(19) United States
(12) Patent Application Publication
(10) Pub. No.: US 2004/0182504 A1
(43) Pub. Date: Sep. 23, 2004

(54) Method for the manufacture of corrugated board

(75) Inventors: Norbert Stadele, Parkstein (DE); Felix Titz, Weiherhammer (DE)

Correspondence Address: BROWDY AND NEIMARK, P.L.L.C., 624 NINTH STREET, NW, SUITE 300, WASHINGTON, DC, 20001-5303, US

(73) Assignee: BHS Corrugated Maschinen-und Anlagenbau GmbH, Weiherhammer (DE)

(21) Appl. No.: 10/805,433

(22) Filed: Mar. 22, 2004

(30) Foreign Application Priority Data
Mar. 21, 2003 (DE) 103 12 601.5

(51) Int. Cl. B31F 1/20

(52) U.S. Cl. 156/210; 156/277

(57) ABSTRACT

A web of material serves for use in a corrugating machine for the manufacture of sheets of corrugated board. The corrugating machine comprises at least two unroll stands for unwinding webs of material. A fluting unit serves for the manufacture of at least one corrugated medium from one of the webs of material. A processing equipment serves for uniting the webs of material to form a web of corrugated board. The sheets of corrugated board are cut from the web of corrugated board by means of a cutting unit. A printing system is provided for printing at least one of the webs. The web of material has a coating for improved printing quality. A method for the manufacture of sheets of corrugated board is specified, using such a web of material. The results are sheets of corrugated board with improved imprint.

### BACKGROUND OF THE INVENTION

1. Field of the Invention

The invention relates to a method for the manufacture of sheets of corrugated board on a corrugating machine, comprising at least two unroll stands for unwinding webs of material from reels of material; at least one fluting unit for the manufacture of at least one corrugated medium from one of the webs of material; at least one processing equipment for uniting the corrugated medium and at least another web of material to form a web of corrugated board; a cutting station for cutting the sheets of corrugated board from the web of corrugated board; a printing system for printing at least one of the webs.

2. Background Art

Corrugating machines for the manufacture of single-faced corrugated board or multi-layer corrugated board are for example known from U.S. Pat. No. 5,632,850. Simple and flexible methods of printing webs of corrugated board have not been known.

### SUMMARY OF THE INVENTION

It is an object of the invention to develop a web of material for the manufacture of corrugated board of the type mentioned at the outset in such a way that the quality of printing this web of material is improved. This object is attained in that a coating for improved printing quality is applied to at least one web which is to be printed and in that the web is printed.

The invention is based on the idea that the coatings used for improved printing quality in other fields, for instance in printing special paper or special films for office purposes, can also be used when webs of material of corrugating machines are printed. This is surprising, given the different nature of the starting material. The coating—also called primer—which improves the printing quality results in that the printing ink can be applied accurately and, in particular, will not run once it has been applied. This will augment the achievable printing resolution, thus improving the printing quality. The coated web of material is provided in reels as they are customarily used in corrugating machines. By alternative, the coating, which improves the printing quality, can also be applied directly prior to printing. This coating will help augment the printing quality even in otherwise unmodified corrugating machines.

In the case of digital printing, the print application patterns can be distributed rather flexibly on the web that is to be printed. In particular, it is possible to handle rather small printing jobs, imprinting varying patterns on the webs being feasible without exchange of hardware components of the printing system. The patterns can be printed in various directions, in particular lengthwise and crosswise of the web conveying direction, with varying scaling. It is even possible, in particular when an ink jet printer is used, to print a web of single-faced corrugated board on the side of the corrugated medium, which is not feasible when printing cylinders are used. Any subsequent printing of the sheets of corrugated board or printing of reels of material that are kept in the corrugating machine prior to operation can be dropped.

Details of the invention will become apparent from the ensuing description of several exemplary embodiments, taken in conjunction with the drawing.

### BRIEF DESCRIPTION OF THE DRAWING

FIG. 1 is a view of a first part of a corrugating machine according to a first embodiment;

FIG. 2 is a view of a detail of FIG. 1, on an enlarged scale, in the vicinity of a first web of material;

FIG. 3 is a plan view of a detail of the first web of material in the vicinity upstream of a heater in the first part of the corrugating machine;

FIG. 4 is a plan view of a detail of the first web of material downstream of the heater in the first part of the corrugating machine;

FIG. 5 is a plan view of details of a printed web of material;

FIG. 6 is a view of a second part of the corrugating machine according to the first exemplary embodiment;

FIG. 7 is a view of a second part of a corrugating machine according to a second exemplary embodiment;

FIG. 8 is a view of a first part of a corrugating machine according to a third exemplary embodiment;

FIG. 9 is a view of a second part of a corrugating machine according to the third exemplary embodiment;

FIG. 10 is a view of a first part of a corrugating machine according to a fourth embodiment; and

FIG. 11 is a view of a second part of the corrugating machine according to the fourth embodiment.

### DESCRIPTION OF PREFERRED EMBODIMENTS

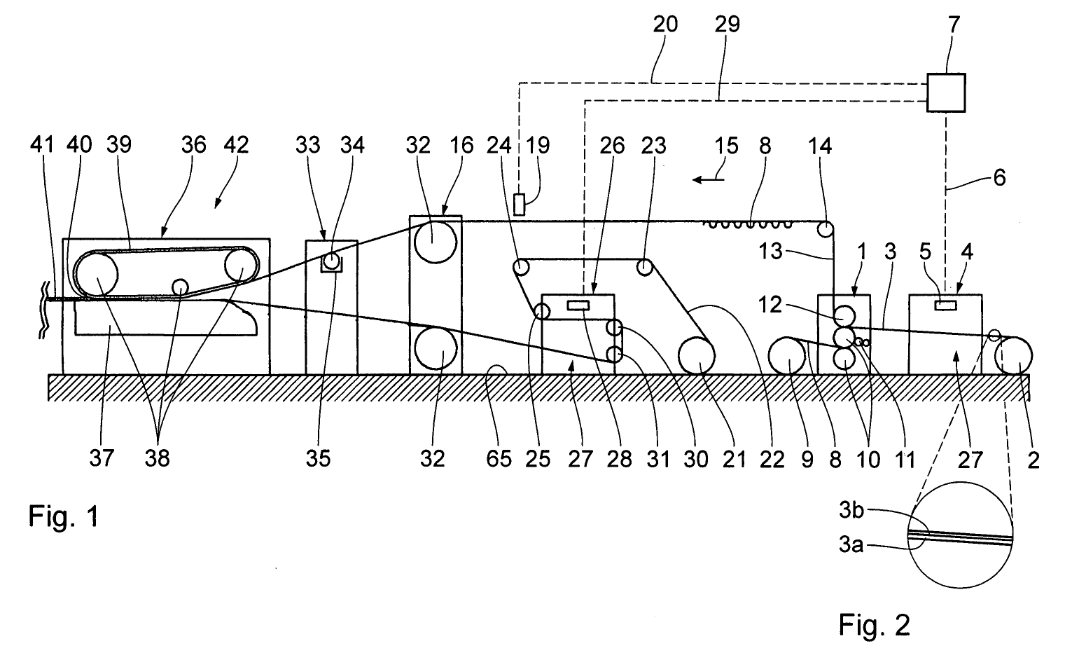

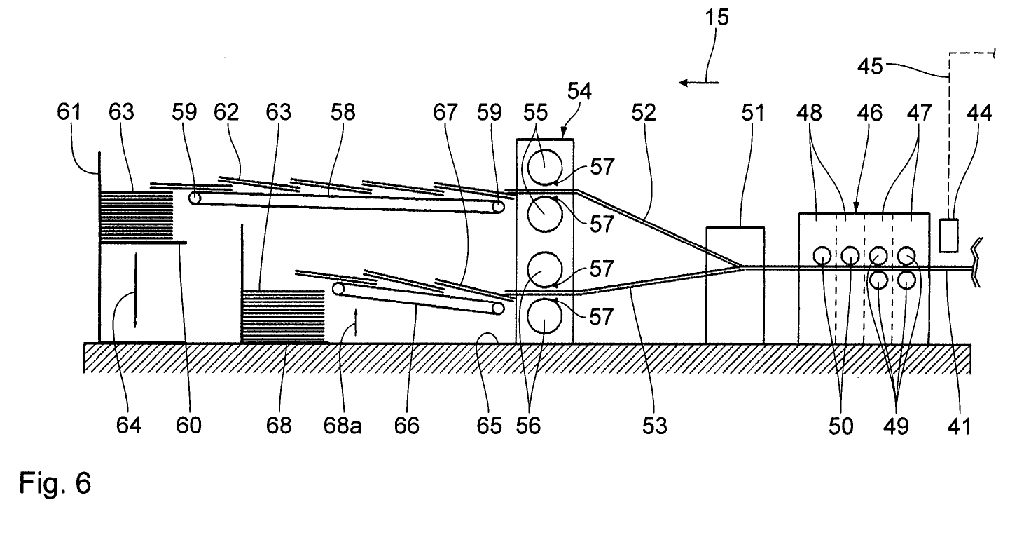

The following is a description of a first embodiment of the invention, taken in conjunction with FIGS. 1 to 6. A corrugating machine as diagrammatically plotted in FIGS. 1 and 6 comprises a machine 1 for the manufacture of single-faced corrugated board. From a first unroll stand 2, a first web of material 3 is fed to the machine 1. The webs of material are continuous paper webs. The web of material 3 constitutes a backer web for the corrugated board manufactured on the machine 1. FIG. 2 is a side view, on an enlarged scale, of the first web of material 3 in detail. It comprises a backer 3a with a primer 3b which improves the printing quality. The backer 3a to primer 3b thickness ratio is not true to scale in FIG. 2. In practice, the primer 3b is substantially thinner as compared to the backer 3a than shown in FIG. 2. The primer 3b must not necessarily be available in a form applied to the web of material 3 when it is rolled up; it can just as well be applied to the web of material 3 later upon unwinding.

Between the first unroll stand 2 and the machine 1, the first web of material 3 passes through a first digital printing unit 4 with an ink jet head 5 which prints the top side of the first web of material in accordance with a printing job. Via a signal line 6, the printing unit 4 is in connection with an application control unit 7.

In the machine 1, the printed first web of material 3 is united with a second web of material 8 which is supplied from a second unroll stand 9. When unrolled, the second web of material 8 passes between two adjacent fluted rollers 10 which are allocated to each other for producing a corrugation. After passing there-through, the second web of material 8 is available in the form of a corrugated medium 8. Then adhesive is applied to the tips of the medium 8 in an adhesive applicator unit 11, and the medium 8 and the first web of material 3 are pressed together and united in a nip between a nip roller 12 and one of the fluted rollers 10. Consequently, the machine 1 is a first production unit of a processing equipment 42 for uniting webs of material to form a web of corrugated board. A single-faced web of corrugated board 13 is discharged upwards from the machine 1 and deflected about a deflection roller 14 into a working direction 15. The machine 1 for the manufacture of single-faced corrugated board is generally known for example from U.S. Pat. No. 5,632,850, GB 2 305 675 A or DE 43 05 158 A1, to which reference is made for details.

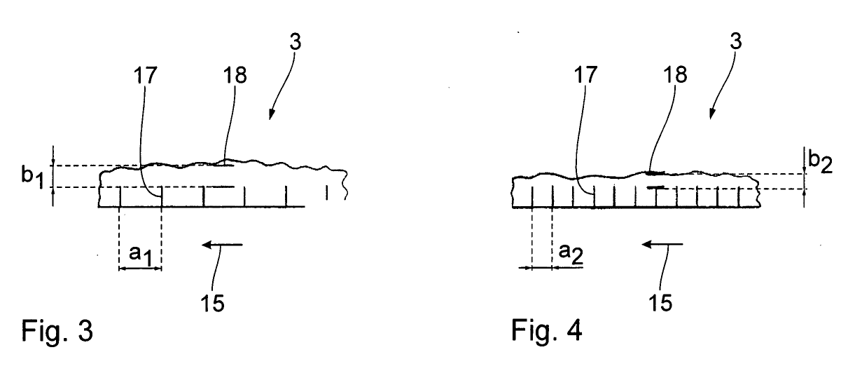

FIGS. 3 and 4 illustrate details of the first web of material 3 in a plan view. FIG. 3 shows the web of material 3 prior to it passing, in the working direction 15, through a pre-heater 16 downstream of the deflection roller 14. The first web of material 3 marginally comprises first marks 17 which are equidistant division marks that extend crosswise of the working direction 15. Upstream of the pre-heater 16, two adjacent first marks 17 have a distance a, from each other. At regular distances in the working direction 15, the first web of material further comprises stripes of second marks 18 which are equidistant short division marks that are parallel to the working direction 15. Upstream of the pre-heater 16, two adjacent marks 18 have a distance b₁ from each other. FIG. 4 shows the web of material 3 in an illustration similar to FIG. 3 downstream of the pre-heater 16. The distance between two adjacent first marks 17 is a₂ and the distance between two adjacent second marks 18 is b₂. Owing to shrinkage of the web of corrugated board 13 after being heated in the pre-heater 16 and owing to the modifications, resulting therefrom, in the dimensions of the web of material 3, the following applies to the distances: a₂<a₁ and b₂<b₁.

A reader 19, which is disposed above the web of corrugated board and thus above the top side of the first web of material 3 that carries the marks 17, 18 and between the deflection roller 14 and the pre-heater 16, determines the distances a₁ and b₁ between adjacent marks 17, 18. To this end the reader 19 is similar to a bar code scanner. Via a signal line 20, the reader 19 is in connection with the application control unit 7.

A second unroll stand 21 for a third web of material 22 as another liner of the single-faced web of corrugated board 13 is disposed downstream of the machine 1 in the working direction 15. The corrugated medium 8, the first web of material 3 which is the backer web, and the third web of material 22 which is the liner web are suitably selected paper webs. In part, it is also usual to call the third web of material 22 the liner web, with the first web of material 3 in this case being called primer web. The webs of material 3, 8 and 22 are unrolled at a speed of up to 400 m/min.

Downstream of the second unroll stand 21, the third web of material 22 is first deviated about a deflection roller 23 so that it runs in the working direction 15. Then the third web of material 22 is deviated by 180° by another two deflection rollers 24, 25 so that the side that faces downwards between the deflection rollers 23 and 24 is now turned upwards, the third web of material 22, downstream of the deflection roller 25, running counter to the working direction 15. Downstream of the deflection roller 25, the third web of material 22 passes through a second printing unit 26 which cooperates with the first printing unit 4, forming a digital printing system 27. The side of the third web of material 22 that is turned upwards downstream of the deflection roller 25 is printed by an ink jet head 28 in the printing unit 26, in accordance with a printing job. The third web of material 22 is also of two-layer design, having a backer and a primer such that the ink jet head 28 of the second printing unit 26 imprints the primer of the third web of material 22. The primer of the third web of material can also be applied after being unrolled and upstream of the second printing unit 26.

For print application control, the second printing unit 26 is in connection with the application control unit 7 via a signal line 29. After passing the second printing unit 26, the third web of material 22, by the aid of another two deflection rollers 30, 31, is again deflected substantially by 180° so that downstream of the deflection roller 31, the third web of material 22 again runs substantially in the working direction 15.

Downstream of the deflection roller 31, the third web of material is fed to the pre-heater 16. The pre-heater 16 comprises two heating rollers 32 that can be heated and are disposed one on top of the other. The single-faced web of corrugated board 13 and the third web of material 22 run one on top of the other, partially being in contact with the respective heating rollers 32. An adhesive applicator unit 33 is disposed downstream of the pre-heater 16, having an adhesive roller 33 which partially dips into an adhesive pan 35. The medium 8 of the web of single-faced corrugated board 13 is in contact with the adhesive roller 34.

Downstream of the adhesive applicator unit 33, provision is made for a heating contact pressure device 36 which comprises a horizontal hot plate table 37 that extends in the working direction 15. A continuously driven contact pressure belt 39 is provided above the table 37; it is deflected by way of three rollers 38. A nip 40 is formed between the contact pressure belt 39 and the table, with the web of single-faced corrugated board 13 and the third web of material 22 passing through the nip 40 where they are pressed one upon the other. A corresponding heating device 36 is known from DE 199 54 754 A1. A three-layer web of corrugated board 41 is being formed in the heating device 36. The heating device 36 and the table 37 constitute a second production unit of the processing equipment 42 for uniting webs of material to form a web of corrugated board 41.

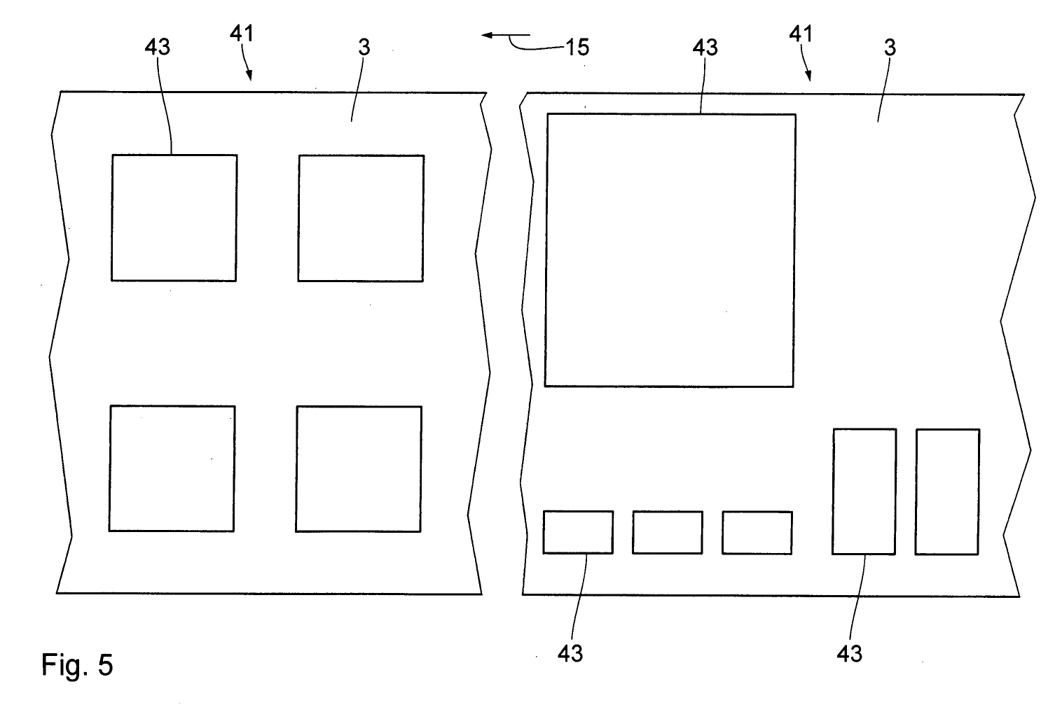

FIG. 5 shows two sections of the printed first web of material 3 as part of the web of corrugated board 41 after discharge from the heating device 36. Various printing patterns 43 are illustrated, which are necessary for printing certain sizes and types of boxes or cartons. As seen in FIG. 5 by way of example, the printing patterns 43 may differ in dimensions lengthwise or crosswise of the working direction 15.

The printing patterns 43 are for example advertising imprints, or instructions in the form of folding or cutting stencils, or printed numbers or dates, or imprints dealing with a certain batch of goods that must be wrapped by the aid of the sheets of corrugated board 62, 67. They may be clearly worded, readable information or bar codes. Owing to the possibilities of the digital printing system 27, printing-pattern-43 variations are virtually unlimited. It is for instance conceivable to design the patterns 43 so that they represent individual parts of an entire picture which originates when sheets 62, 67 with these individual parts of printing patterns are joined or when wrappings are produced from these sheets.

FIG. 6 illustrates a second part of the corrugating machine, following the discharge of the web of corrugated board 41 from the heating device 36. At the upstream end of FIG. 6, a second reader 44 is disposed above the web of corrugated board 41. The reader 44 is in connection with the application control unit 7 via a signal line 45 illustrated by dashes in FIG. 6. The second reader 44 registers the top side of the web-of-material-3 section seen in FIG. 4. The second reader 44 measures the distances a₂, b₂ between adjacent first marks 17 and adjacent second marks 18.

Downstream of the reader 44—seen in the working direction 15—a lengthwise cutting/grooving unit 46 is disposed, consisting of two successive grooving stations 47 and two successive lengthwise cutting stations 48. The grooving stations 47 have grooving tools 49 which are arranged in pairs one on top of the other, with the web of corrugated board 41 passing there-between. The lengthwise cutting stations 48 have rotatably drivable cutters 50 which are movable into engagement with the web of corrugated board 41 for it to be cut lengthwise. The detailed design of the lengthwise cutting/grooving unit 46 is known from U.S. Pat. No. 6,071,222 and DE 101 31 833 A which reference is made to for further details of design.

Downstream of the lengthwise cutting/grooving unit 46—seen in the working direction 15—provision is made for a shunt 51 where lengthwise cut sections 52, 53 of the web of corrugated board 41 are separated. The web sections 52, 53 are then fed to a cross-cutting unit 54. It comprises a pair of top crosscutting rollers 55 for the top web section 52 and a pair of bottom crosscutting rollers 56 for the bottom web section 53. The rollers of the pairs of rollers 55, 56 each have a cutter bar 57 which is perpendicular to the working direction 15, extending radially outwards. The cutter bars 57 of a pair of crosscutting rollers 55, 56 cooperate for crosscutting the web sections 52, 53. A top conveyor belt 58 is disposed downstream of the top pair of crosscutting rollers 55; it is deviated by rotatably drivable rollers 59. Downstream of the top conveyor belt 58, provision is made for a place of deposit 60 with a vertical stop 61 where sheets of corrugated board 62, which have been cut from the web section 52 by means of the crosscutting unit 54, are piled up, forming a stack 63. As roughly outlined by an arrow 64 in FIG. 6, the place of deposit 60 is adjustable in height. For further dis-patch of the stack 63, the place of deposit 60 can in particular be lowered as far as to a bottom 65 that supports the corrugating machine.

Another bottom conveyor belt 66 is disposed downstream of the pair of crosscutting rollers 56, stacking sheets of corrugated board 67 on another place of deposit 68; the sheets are cut from the web section 53 by means of the crosscutting unit 54. For adaptation to the height of the stack 63, the bottom conveyor belt 66 can be lifted as roughly outlined by the arrow 68a.

Printing the web of corrugated board 41 with patterns 43 takes place as follows: First the webs of material are provided with primers and supplied to the unroll stands 2 and 21. The primers may also be dropped, in which case a non-coated web of material is made available at the unroll stand 9. By alternative, the primer can also be applied directly upstream of the printing units 4, 26 after the webs of material have been unrolled. The marks 17, 18 are applied by the printing unit 4. Then the corrugating machine starts running, producing a non-printed web of corrugated board 41. This continues until the web of corrugated board that is produced has reached the area where it is registered by the second reader 44. The two readers 19, 44 then register the distances a₁, b₁ and a₂, b₂ of the marks 17 and 18. The readers 19, 44 then pass this information to the application control unit 7. Based on the ratio a₂/a₁ of the distances of the marks 17 upstream and downstream of the heating devices 16, 36, a computer of the application control unit 7 determines a degree of longitudinal shrinkage of the webs of material 3, 8, 22 in the working direction 15, i.e. a modification of the web dimensions in the longitudinal direction between the web in the vicinity of the first printing unit 4 of the printing system 27 on the one hand (reader 19) and the web prior to the sheets 62, 67 being cut on the other hand (reader 44). Correspondingly, cross-shrinkage of the webs of material 3, 8, 22 is determined by the aid of the ratio of the distances b₁, b₂ of adjacent marks 18 in the vicinity of the reader 19 on the one hand and in the vicinity of the reader 44 on the other. Determining the cross shrinkage can be dropped as well as the associated marks. The distance parameters a₁, a₂, b₁, b₂ are transmitted by the readers 19, 44 to the application control unit 7.

The degrees of shrinkage of the web of corrugated board 41 in the longitudinal and cross direction, which are determined by the application control device 7, serve for the application control device 7 to determine scaling factors for the printing pattern 43 that will be applied by the printing units 4 and 26. The printing units 4 and 26 apply the printing patterns 43 by dimensional reservation so that the desired size of the printing patterns 43 will appear on the web sections 52, 53 owing to the pre-determined shrinkage of the web. Simultaneously, the application control unit 7, via signal lines (not shown), controls the lengthwise cutting stations 48 on the one hand and the crosscutting unit 54 on the other in accordance with the printing jobs transmitted by the application control unit 7 to the printing system 27. The sheets of corrugated board 62, 67 are cut in such a way that the printing patterns 43 are located at pre-determined places on the sheets 62, 67. The printing jobs transmitted from the application control unit 7 to the printing system 27 may involve small or minimal serial manufacture of only few sheets of corrugated board 62, 67. Upon modification of the printing job, the lengthwise cutting stating 48 is triggered by the application control unit 7 so that the width of the web sections 52, 53 is cut correspondingly. Instead of the illustrated cross-cutting unit 54 with pairs of rollers 55, 56, use can be made of a cross-cutting unit which is equally triggered by the application control unit 7, enabling sheets of corrugated board of varying lengths to be cut in the working direction 15. The sheets of corrugated board 62, 67 can then be adapted in size perfectly flexibly to the shape and size of the printing patterns 43 of the respective printing jobs.

If necessary, prior to being printed, the sides of the webs of material 3, 22 that are to be printed can be cleaned by a corresponding equipment, for instance a compressed air sprayer. Sucking off is conceivable alternatively of blowing off the sides, to be printed, of the webs of material 3 and 22. Finally, it is also possible to prepare the webs of material 3, 22 in such a way that they are antistatic, dust being prevented from depositing on the sides that are to be printed. Preferably, printing the webs of material 3, 22 takes place in an air-conditioned environment. The temperature is kept at less than 40° C. Once the webs of material 3, 22 have been printed, the printed sides can be sealed by a corresponding protective layer being applied. This type of sealing can take place prior to or after the sheets of corrugated board 62, 67 are cut.

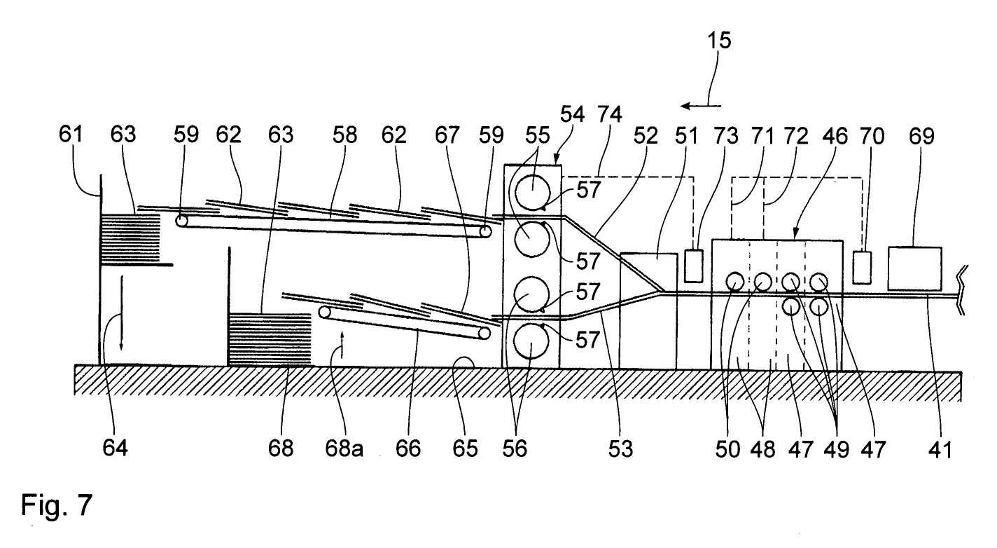

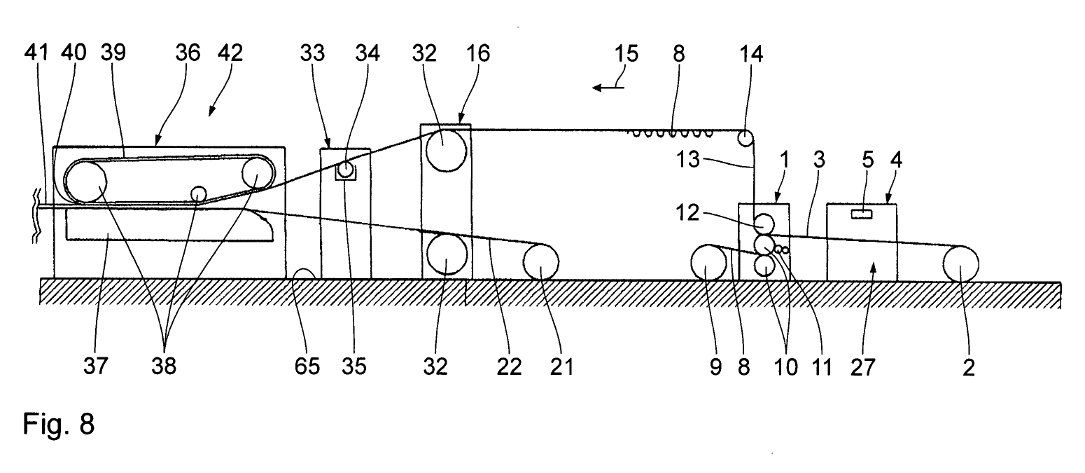

FIG. 7 illustrates a second part of a corrugating machine according to a second embodiment. FIGS. 8 to 11 illustrate further embodiments of corrugating machines. Components that correspond to those described with reference to FIGS. 1 to 6 have the same reference numerals and are not going to be explained in detail again.

In the corrugating machine according to the second embodiment, a digital printing system 69 is disposed downstream of the heater (not shown). With no relevant shrinkage of the web taking place between the jobs of printing the web of corrugated board 41 and depositing the cut sheets of corrugated board 62, 67, the readers 19, 44 of the first embodiment can be dropped.

In the second exemplary embodiment, a reader 70 is disposed upstream of the lengthwise cutting/grooving unit 46, crosswise scanning the web of corrugated board 41 and recognizing the distribution of printing patterns 43 on the web of corrugated board 41. Signal lines 71, 72 provide for signalling connection of the reader 70 with the lengthwise cutting stations 48. Depending on recognition of the printing patterns 43 by the reader 70, the lengthwise cutting stations 48 are triggered for web sections 52, 53 to be cut, having a width that corresponds to the arrangement of the printing patterns.

Another reader 73 is disposed between the lengthwise cutting/grooving unit 46 and the cross-cutting unit 54, within its range scanning the web sections 52, 53 of the web of corrugated board in the working direction 15 i.e., lengthwise, and registering the distribution of printing patterns 43 on the web of corrugated board 41 in the working direction 15. A signal line 74 connects the reader 73 with the cross-cutting unit 54. Corresponding to what has been said about lengthwise cutting of the web of corrugated board 41, the reader 73 triggers the cross-cutting unit 54 in such a way that this unit 54 cuts the sheets of corrugated board 62, 67 in accordance with the distribution of printing patterns in the working direction 15. By the aid of the readers 70. 73, a plane shape of the sheets of corrugated board can be determined, the longitudinal and transverse dimensions of which are adjustable; this plane shape can be cut to size by the lengthwise cutting stations 48 and the cross-cutting unit 54 being correspondingly triggered.

In variation of the second embodiment, printing units may be provided in addition to the printing system 69, corresponding to the printing units 4 and 26 of the first embodiment for printing individual webs of material upstream of the machine 1 or the heating device 36.

In further variation of the second embodiment, the printing system 69 can be provided with two ink jet heads in such a way that the web of corrugated board 41 is bilaterally printed, i.e. simultaneously on the top and bottom side.

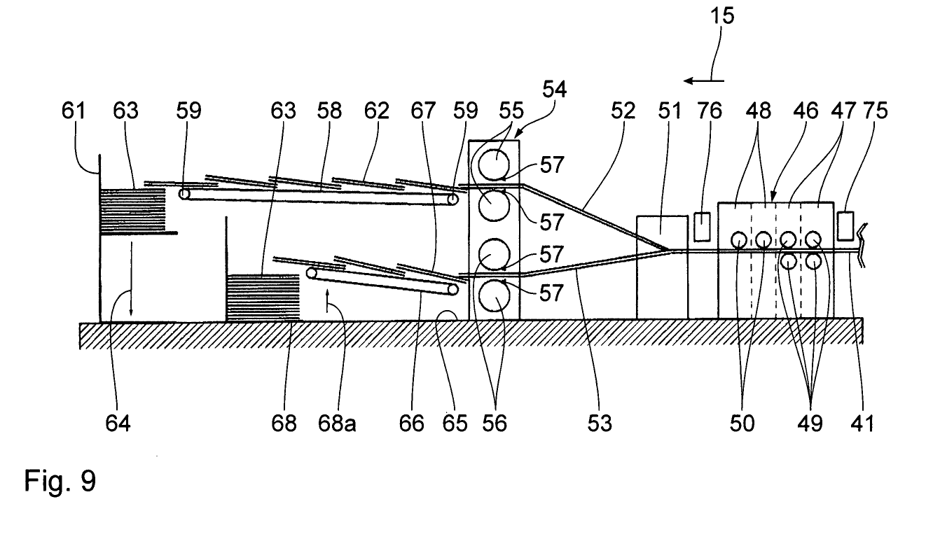

FIGS. 8 and 9 show the two parts of a corrugating machine according to a third embodiment. As compared to the first embodiment, the second printing unit 26 misses in the first part, seen in FIG. 8, of the corrugating machine. Also the deviation of the third web of material by the deflection rollers 23, 24, 25, 30, 31 has been dropped, which is no longer needed. Further, the first reader 19 misses in the third embodiment. The application control unit exists also in this embodiment, however it is not shown. In the corrugating machine of the third embodiment, a first web of material 3 is being printed, having marks 17, 18 at an initial distance that is given and has been fed into the application control unit of the third embodiment prior to the start of production of the corrugating machine. Therefore the application control unit of the third embodiment knows the distances a₁, b₁ although they have not been measured by a reader.

The second part of the third embodiment of the corrugating machine seen in FIGS. 9 corresponds to the second part of the corrugating machine of the first embodiment seen in FIG. 6, a difference residing in that the reader 44 of the first embodiment, which evaluates the distance from each other of the marks 17 and the marks 18, is functionally split into a first reader 75 for determination of the distance of the marks 17 and a second reader 76 for determination of the distance of the marks 18. Signal lines (not shown) connect the readers 75, 76 to the application control unit of the corrugating machine of the third embodiment.

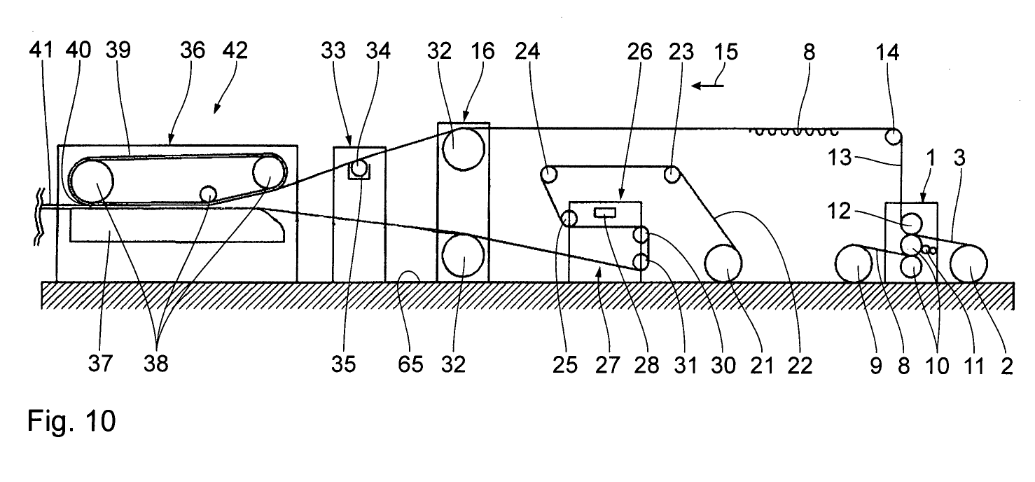

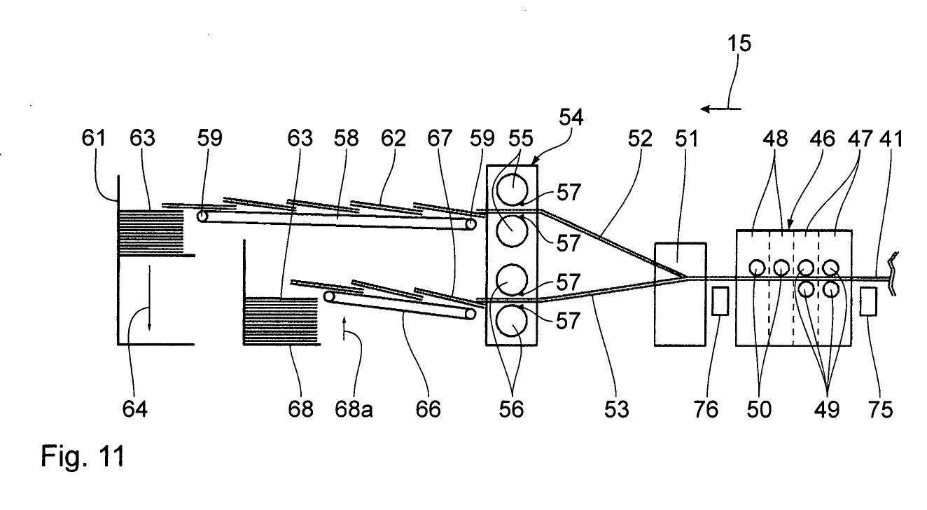

FIGS. 10 and 11 illustrate the two parts of a corrugating machine of a fourth embodiment. These parts correspond to those of the third embodiment with the difference that the web of corrugated board, in the fourth embodiment, is printed from below instead of from above. Therefore, the printing unit 4 misses in the first part of the corrugating machine of the fourth embodiment. It is replaced by the printing unit 26 which corresponds to the first embodiment, serving for printing the bottom side of the third web of material 22. Correspondingly, in the second part of the corrugating machine of the fourth embodiment, the readers 75, 76 are located underneath the web of corrugated board 41, there registering the printing patterns imprinted by the printing unit 26. Otherwise, the fourth embodiment corresponds to the third embodiment.

The readers 19, 44, 70, 73, 75, 76 may be embodied as a camera, in particular a CCD camera. In addition to the function described above, the reader 19 still has the function of synchronizing the two printing units 4, 26 when bilaterally accurately aligned printing is to take place on the web of corrugated board 41. To this end, the reader 19 registers the time when a certain printing pattern 43 finds itself within in the range of the reader 19.

Depending on the difference of the conveying paths of the web of single-faced corrugated board 13 from the reader 19 as far as to the nip 40 on the one hand and of the third web of material 22 from the ink jet head 28 as far as to the nip 40 on the other hand, the application control unit 7 computes the instant at which the printing unit 26 must print the third web of material 22 for this third web 22 to be printed true to the position of the print on the opposite side of the web of corrugated board, which is the top side of the web of corrugated board 13 that is printed by the printing unit 4.

What is claimed is:

1. A method for the manufacture of sheets of corrugated board (62, 67) on a corrugating machine, comprising
at least two unroll stands (2, 9, 21) for unwinding webs of material (3, 8, 22) from reels of material;
at least one fluting unit (10) for the manufacture of at least one corrugated medium (8) from one of the webs of material;
at least one processing equipment (1, 36, 37) for uniting the corrugated medium (8) and at least another web of material (3, 22) to form a web of corrugated board (41);
a cutting station (48, 54) for cutting the sheets of corrugated board (62, 67) from the web of corrugated board (41);
a printing system (27; 69) for printing at least one of the webs (3; 41); comprising the following steps:
applying a coating (3b) for improved printing quality on at least one web (3) which is to be printed;
printing the web (3) which is to be printed.

2. A method according to claim 1, wherein the print is sealed after printing.

3. A method according to claim 1, wherein the web (3; 41) which is to be printed is printed digitally.

4. A method according to claim 1, wherein the environment of the web (3; 41) which is to be printed is air-conditioned during printing.

5. A method according to claim 1, wherein a temperature is kept during printing, which is lower than 40° C.

6. A method according to claim 1, wherein the at least one web (3) which is to be printed is cleaned prior to printing.
